(19) United States
(12) Patent Application Publication
(10) Pub. No.: US 2005/0032967 A1
(43) Pub. Date: Feb. 10, 2005

(54) Water-based coating composition for waterproofing walls

(76) Inventors: Michael G. Roberts SR., Akron, OH (US); Michael G. Roberts JR., Cuyahoga Falls, OH (US)

Correspondence Address: Ray L. Weber;Renner, Kenner, Greive, Bobak, Taylor & Weber, Fourth Floor, First National Tower, Akron, OH, 44308-1456, US

(21) Appl. No.: 10/888,214

(22) Filed: Jul. 9, 2004

Related U.S. Application Data
(60) Provisional application No. 60/485,886, filed on Jul. 9, 2003.

(51) Int. Cl. C08K 3/00; B32B 25/04

(52) U.S. Cl. 524/515; 523/221; 428/492

(57) ABSTRACT

A wall comprising a first surface, and a protective coating covering at least a portion of the first surface, where the coating is the dried film of an aqueous composition comprising a first set of polymer particles characterized by having a glass transition temperature that is less than about −40° C., and a second set of polymer particles characterized by having a glass transition temperature in excess of about −25° C.

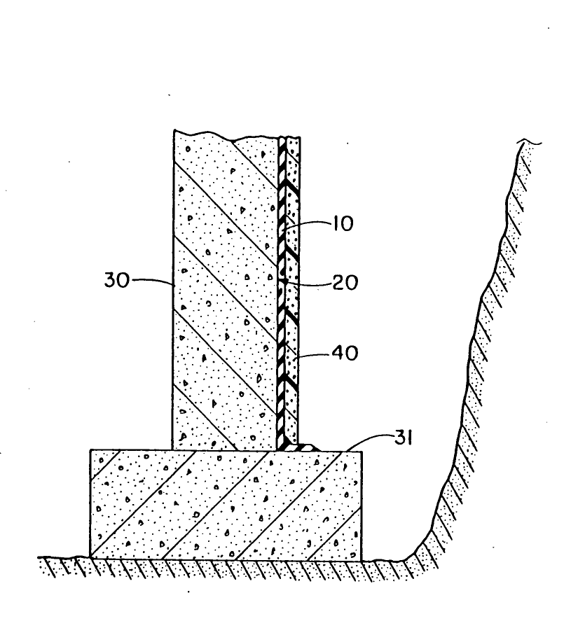

This application claims the benefit of U.S. Provisional Ser. No. 60/485,886, filed on Jul. 9, 2003.

### FIELD OF THE INVENTION

Water-based coating compositions, the cured films thereof, and walls that are coated with films are provided.

### BACKGROUND OF THE INVENTION

As is shown in U.S. Pat. Nos. 5,932,646 and 5,925,706, polymeric compositions for waterproofing walls, particularly below-grade walls, are known. Although these compositions and the films or coatings resulting therefrom have proven to be technologically significant, these compositions rely on organic solvents to carry the polymer to the substrate being treated. Although these organic solvents are generally environmentally friendly, health and environmental trends suggest that the elimination of all organic solvents would be highly favorable. As a result, there is a need to develop polymeric compositions for coating walls, particularly below-grade walls to provide a water impervious barrier, where the compositions are free of organic solvents.

### SUMMARY OF THE INVENTION

In general the present invention includes a wall comprising a first surface, and a protective coating covering at least a portion of the first surface, where the coating is the dried film of an aqueous composition comprising a first set of polymer particles characterized by having a glass transition temperature that is less than about −40° C., and a second set of polymer particles characterized by having a glass transition temperature in excess of about −25° C.

The present invention further includes an aqueous composition for waterproofing walls, the composition comprising comprising a first set of polymer particles characterized by having a glass transition temperature that is less than about −40° C., and a second set of polymer particles characterized by having a glass transition temperature in excess of about −25° C.

The present invention further includes a method for waterproofing a below-grade wall, the method comprising applying an aqueous composition to the wall, the aqueous composition comprising a first set of polymer particles characterized by having a glass transition temperature that is less than about −40° C., and a second set of polymer particles characterized by having a glass transition temperature in excess of about −25° C.

### DRAWINGS

The figure is a vertical, cross-sectional partial view of a wall having a protective coating thereon.

### DETAILED DESCRIPTION OF ILLUSTRATIVE EMBODIMENTS

The water-based coating compositions of this invention include aqueous emulsions or latexes that include a heterogeneous blend of dispersed polymer particles. The coating composition is preferably applied to a wall and air dried or cured to form a protective film on the wall.

The heterogeneous blend of dispersed polymer particles includes a first and second set of polymer particles. In one or more embodiments, the first set of polymer particles are preferably characterized by a glass transition temperature (Tg) that is less than about −40° C., more preferably less than about −50° C., even more preferably less than about −60° C., and still more preferably from about −70° C. to about −90° C. as determined by using DSC techniques on dried samples or films prepared from the latex.

In one or more embodiments, the first set of polymer particles may also preferably be characterized by having a viscosity at about 25° C. that is greater than about 3 centipoise (cps), more preferably greater than about 5 cps, even more preferably greater than about 15 cps, and still more preferably greater than about 30 cps; and the viscosity at about 25° C. is preferably less than about 500 cps, more preferably less than about 250 cps, even more preferably less than about 100 cps, and still more preferably less than about 70 cps, as measured using a Brookfield RV viscometer with a #3 spindle and at 20 r.p.m.

In one or more embodiments, the first set of polymer particles, as they exist within the latex composition, are preferably further characterized by an average particle size that is greater than 50 nanometers (nm), more preferably greater than about 100 nm, even more preferably greater than about 150 nm, and still more preferably greater than about 180 nm; and the particle size is preferably less than about 500 nm, more preferably less than about 350 nm, even more preferably less than about 250 nm, and still more preferably less than about 220 nm.

In one or more embodiments, the first set of polymer particles are preferably characterized by having a modulus that is higher than that of the second set of polymer particles as determined by tensile strength according to ASTM D-412 on dried films of the latexes.

In one or more embodiments, the first set of polymer particles includes natural rubber, synthetically-synthesized emulsion polymers, or mixtures thereof. The natural rubber can derive from a variety of sources including the Hevea brasiliensis tropical tree. The natural rubber may be treated according to conventional rubber latex treatment processes. Where the first set of polymer particles include synthetically-synthesized emulsion polymers, they may include those polymers that derive from the polymerization of soft monomers including conjugated dienes and certain alkyl acrylates. Useful conjugated dienes include 1,3-butadiene. Copolymers of soft monomers and styrene may also be included.

In one or more embodiments, the second set of polymer particles are preferably characterized by a glass transition temperature (Tg) that is greater than about −25° C., more preferably greater than about −10° C., even more preferably greater than about 0° C., and still more preferably from about 10° C. to about 40° C. as determined by using DSC techniques on dried samples or films prepared from the latex.

In one or more embodiments, the second set of polymer particles may also preferably be characterized by having a viscosity at about 25° C. that is greater than about 5 cps, more preferably greater than about 500 cps, even more preferably greater than about 1000 cps, and still more preferably greater than about 1500 cps; and the viscosity at about 25° C. is preferably less than about 5500 cps, more preferably less than about 5000 cps, even more preferably less than about 4500 cps, and still more preferably less than about 4000 cps, as measured using a Brookfield RV viscometer with a #3 spindle and at 20 r.p.m.

In one or more embodiments, the second set of polymer particles, as they exist within the latex composition, are preferably further characterized by an average particle size that is greater than about 50 nm, more preferably greater than about 100 nm, even more preferably greater than about 150 nm, and still more preferably greater than about 180 nm; and the particle size is preferably less than about 500 nm, more preferably less than about 350 nm, even more preferably less than about 250 nm, and still more preferably less than about 220 nm.

In one or more embodiments, the second set of polymer particles are preferably characterized by having a higher elongation than the first set of polymer particles as determined by elongation analysis per ASTM D-412 on dried films of the latexes.

In one or more embodiments, the second set of polymer particles includes polymers prepared by the emulsion polymerization of acrylic monomers alone or in combination with one or more comonomers. Acrylic monomers include acrylic acid, methacrylic acid, acrylic acid esters, methacrylic acid esters, derivatives of acrylic acid, derivatives of methacrylic acid, and mixtures thereof.

Examples of acrylic and methacrylic ester monomers include C₁-C₃₀ alkyl ester derivatives. Methacrylic esters suitable for use in the present invention include, but are not limited to, the following: methyl methacrylate, ethyl methacrylate, n-propyl methacrylate, n-butyl methacrylate, isopropyl methacrylate, isobutyl methacrylate, n-amyl methacrylate, n-hexyl methacrylate, isoamyl methacrylate, 2-hydroxyethyl methacrylate, 2-hydroxypropyl methacrylate, N,N-dimethylaminoethyl methacrylate, N,N-diethylaminoethyl methacrylate, t-butylaminoethyl methacrylate, 2-sulfoethyl methacrylate, trifluoroethyl methacrylate, glycidyl methacrylate, benzyl methacrylate, allyl methacrylate, 2-n-butoxyethyl methacrylate, 2-chloroethyl methacrylate, sec-butyl-methacrylate, tert-butyl methacrylate, 2-ethybutyl methacrylate, cinnamyl methacrylate, crotyl methacrylate, cyclohexyl methacrylate, cyclopentyl methacrylate, 2-ethoxyethyl methacrylate, furfuryl methacrylate, hexafluoroisopropyl methacrylate, methallyl methacrylate, 3-methoxybutyl methacrylate, 2-methoxybutyl methacrylate, 2-nitro-2-methylpropyl methacrylate, n-octylmethacrylate, 2-ethylhexyl methacrylate, 2-phenoxyethyl methacrylate, 2-phenylethyl methacrylate, phenyl methacrylate, propargyl methacrylate, tetrahydrofurfuryl methacrylate and tetrahydropyranyl methacrylate.

Acrylate esters suitable for use in the present invention include methyl acrylate, ethyl acrylate, n-propyl acrylate, isopropyl acrylate, n-butyl acrylate, n-decyl acrylate, 2-ethylhexyl acrylate, and the like.

Methacrylic acid derivative monomers suitable for use in the present invention include: methacrylic acid and its salts, methacrylonitrile, methacrylamide, N-methylmethacrylamide, N-ethylmethacrylamide, N,N-diethymethacrylamide, N,N-dimethylmethacrylamide, N-phenyl-methacrylamide, methacrolein, and the like.

Acrylic acid derivatives suitable for use in the present invention include: acrylic acid and its salts, acrylonitrile, acrylamide, methyl alpha-chloroacrylate, methyl 2-cyanoacrylate, N-ethylacrylamide, N,N-diethylacrylamide acrolein, and the like.

Comonomers that can be copolymerized with one or more of the acrylic monomers include vinyl aromatic monomers, acidic monomers, ethylene monomers, and mixtures thereof.

Vinyl aromatic monomers include styrene and alpha-methyl styrene.

Acidic monomers include alpha-beta-unsaturated carboxylic acids such as itaconic acid, methacrylic acid, citraconic acid, cinnamic acid, fumaric acid, malice acid, and mixtures thereof.

Ethylenic monomers suitable for use in the present invention include vinyl pyridine, vinyl pyrollidone, sodium crotonate, methyl crotonate, crotonic acid, maleic anhydride, and the like.

In addition to the first and second set of polymer particles, the aqueous compositions of this invention may optionally include other additives. These additional additives include, but are not limited to, surfactants, thixotropic agents, defoamers, tackifier resins, fillers, pigments, biocides, plasticizers, flow agents, and anti-freezes.

Useful surfactants include nonionic surfactants, anionic surfactants, and combinations thereof. Anionic surfactants include those obtained by alkylating aromatic nuclei, suflonating the resulting alkylated aromatic hydrocarbons, and neutralizing the sulfonating products. Examples include alkyl benzene sulfonates, such as dodecylbenzenesulfonate. Fatty alcohol sulfates are also useful. Other examples include alkyl sulfates, alkali metal salts of alkyl sulfates, alkali metal salts alkyl sulfosuccinates, ether sulfates, phosphate esters, sulfonates, and the like.

Nonionic surfactants include alcohol ethoxylates (polyoxyalkylene derivatives of propylene glycol), alkylphenol ethoxylate (polyethylene oxide condensates of alkylphenols), phenol ethoxylate, condensates of ethylene oxide and the reaction product of propylene oxide and ethylene diamine, ethylene oxide condensates of aliphatic alcohols, long chain tertiary amine oxides, long chain tertiary phosphine oxides, long chain dialkyl sulfoxides and the like.

Useful thixotropic agents or antisagging agents that can be used include castor waxes, fumed silicas, treated clays, polyamides. Useful sources of the thixotrope include those available under the tradenames AEROSIL (Degussa), TS720 (Cabot), CASTORWAX (Caschern), BENTONE, THIXATROL and THIXCIN (Rheox), DISLON (King), and TEXIPOL 63-001 (Scott Badar; Stow, Ohio), which is believed to be a sodium salt of an acrylic copolymer dissolved or suspended in a paraffinic solvent. Examples of suitable anti-settling agents include fumed silica, montmorillenite clay and liquid waxes. Others include protein thickeners such as casein, certain cellulose derivatives such as hydroxyethylcellulose, acrylic polymers such as sodium polyacrylate and polyacrylic acid, polysaccharides, fumed silicas, and expandable clays such as montmorillonite and attapulgite or aramide fiber pulp.

Coloring pigments include white coloring pigments such as zinc oxide and titanium dioxide, carbon black, iron oxides (red and black), micaceous iron oxide, aluminum powder, phthalocyanine blue and phthalocyanine green.

Fillers include inorganic fillers such as mica, calcium carbonate, calcium oxide and magnesium carbonate and organic fillers such as lignin, proteinaceous materials, synthetic fibers and cellulosic materials.

Useful defoamers or antifoaming agents include include various dispersions such as reacted silica in mineral oil or silicone-based materials. Other examples include a polyglycol and metallic soap blended composite, which is available under the tradename Bubble Breaker 748, (Witco Organics Div.; Houston, Tex.), and modified siloxane copolymer, which is available under the tradename Defoamor 020, (BYK Chemie USA; Wallingford, Conn.). Others include those available under the tradename FOAMASTER NXZ (Cognis Corp.; Cincinnati, Ohio).

Useful microbiocides and mildewcides include phenylmercury compounds such as phenylmercury acetate and di(phenylmercury)-dodecenyl succinate.

Useful tackifier resins include solid tackifying resins, which are solid at room temperature. Combinations of two or more tackifying resins can also be suitably applied. Suitable tackifying resins include polyterpene resins, polyindene resins, rosin esters, hydrogenated rosins, alpha-pinene resins, beta-pinene resins, hydrocarbon resins of petroleum origin and phenolic resins. Useful tackifying resins are available under the tradenames REGALITE R91, R101, R125 and S260, ESCOREZ 1310 and 5380, WINGTACK 95, FORAL. 85 and 105, PICCOLYTE A115, S115 and S10 and PICCOTAC 95E, PERMATAC H7710 (Neville), which is a stabilized rosin dispersion.

The latex compositions of this invention preferably include a solids content that is greater than about 35%, more preferably greater than about 38%, even more preferably greater than about 40%, and still more preferably greater than about 43% by weight, and preferably less than about 70%, more preferably less than about 65%, even more preferably less than about 60%, and still more preferably less than about 55% by weight, based on the total weight of the latex.

The solids content of the lattices preferably includes greater than about 75%, more preferably greater than about 80%, even more preferably greater than about 85%, and still more preferably greater than about 90% by weight of the heterogeneous blend of polymer particles (e.g. the first and second set of particles); and preferably includes less than about 99%, more preferably less than about 97%, even more preferably less than about 94%, and still more preferably less than about 92% by weight of the blend of heterogeneous blend of polymer particles. Inasmuch as the films of this invention are the dried product of the latex, the compositional qualitative and quantitative characteristics of the films will be the same as the qualitative and quantitative characteristics of the solids portion of the latex (e.g. the films will preferably include at least 75% by weight of the dried residue of the blend of polymer particles).

The blend of polymer particles preferably includes a weight ratio of the first polymer particles to the second polymer particles of from about 1.7:1 to about 1:1.7, more preferably from about 1.5:1 to about 1:1.5, even more preferably from about 1.3:1 to about 1:1.3, and still more preferably from about 1.1:1 to about 1:1.1.

When the compositions include a thixotropic agent, the solids content of the latexes may preferably include from about 1 to about 15 parts by weight, more preferably from about 3 to about 12 parts by weight, even more preferably from about 5 to about 10 parts by weight, and still more preferably from about 6 to about 8 parts by weight thixotropic agent per 100 parts by weight of the blend of polymer particles.

When the compositions include a defoaming agent, the solids content of the latexes may preferably include from about 0.1 to about 10 parts by weight, more preferably from about 0.3 to about 5 parts by weight, even more preferably from about 0.5, to about 3 parts by weight, and still more preferably from about 0.9 to about 1.5 parts by weight defoaming agent per 100 parts by weight of the blend of polymer particles.

When the compositions include a filler and/or pigment agent, the solids content of the latexes may preferably include from about 0.1 to about 10 parts by weight, more preferably from about 0.3 to about 5 parts by weight, even more preferably from about 0.5, to about 3 parts by weight, and still more preferably from about 0.7 to about 2 parts by weight filler and/or pigment agent per 100 parts by weight of the blend of polymer particles.

When the compositions include a tackifying resin, the solids content of the latexes may preferably include from about 1 to about 40 parts by weight, more preferably from about 5 to about 30 parts by weight, and even more preferably from about 15, to about 25 parts by weight tackifying resin per 100 parts by weight of the blend of polymer particles.

The latex compositions of this invention can be prepared by blending an aqueous dispersion or emulsion that includes the first set of polymer particles with an aqueous dispersion or emulsion that includes the second set of polymer particles. Conventional blending techniques can be used and subsequent mixing of the blend may be preferred. The blending and mixing preferably occurs at ambient temperature and pressure. In a preferred embodiment, the aqueous composition of this invention is prepared by blending a natural rubber latex with a styrene-acrylic copolymer latex. Natural rubber latexes are commercially available such as those available under the tradename Hartex™ 101 (Firestone Polymers). Numerous styrene acrylic copolymer latexes are commercially available including those available under the tradenames Texigel™ or Texicryl™ (Scott Bader). These styrene acrylic copolymer latexes may derive from the polymerization of one or more acrylic monomers together with one or more comonomers including styrene.

In one or more embodiments, where a thixotropic agent is employed, certain blending orders or techniques may be preferred. In one embodiment, the latex including the second set of polymer particles (i.e. those having the higher Tg) are blended with the thixotropic agent, pigments, defoamers, and other ingredients. Once these constituents have been blended, the first set of polymer particles (i.e. those having the lower Tg) is added and mixed into the composition.

In one or more embodiments, where a thixotropic compound and a tackifying resin are employed, the thixotropic agent can be added after all of the other constituents are blended, but it is preferred that the thixotropic compound is diluted in an aqueous solution or masterbatch that preferably includes less than about 20% by weight, more preferably less than about 15% by weight, even more preferably less than about 10% by weight, and still more preferably less than about 5% by weight solids or active thixotropic compound.

The aqueous compositions of this invention are advantageously useful for applying to walls to form a protective coating. For example, one or more compositions of this invention can be used to form waterproof, dampproof, or air vapor barrier films or coatings on walls. Accordingly, the term protective coating or film generically refers to waterproof coatings, dampproof coatings, and air-vapor coatings. The criteria defining a waterproof coating have been standardized by Boca Evaluation Services, Inc. of Country Cub, Ill. Namely, waterproof coatings are those that are resilient to water solubility, as defined in ASTM D-2939; resistant to waterflow as defined in ASTM D-466; exhibit adequate tensile properties as defined in ASTM D412; resist hydrostatic pressure over non-structural cracks as defined in TT-C-555B; and have the ability to bridge cracks at 0° F. according to ASTM C836. Dampproof coatings include those that are resistant to waterflow but do not exhibit the ability to resist hydrostatic pressure over non-structural cracks and to bridge cracks at −18° C.

The walls to which the compositions of this invention may be applied include poured concrete walls, masonry block and wood walls. In one or more embodiments, especially where the compositions include a tackifying resin, the dried films produced from the compositions of this invention advantageously exhibit sufficient tack so as to allow the application of a protective material, such as a polystyrene foam board, to the wall.

A wall having a protective coating thereon is shown in the figure. Specifically, coating 10 preferably covers the exterior surface 20 of a wall 30. In those embodiments where wall 30 is a basement wall, the coating preferably covers the entire exterior surface 20 of the basement wall 30 from the foundation base 31 to the expected soil level. An optional protective material 40 (e.g., a polystyrene foam protection board) may at least partially or entirely cover the elastomeric coating.

Advantageously, the compositions of this invention can be applied to the exterior surface of concrete or masonry basement walls by using a variety of techniques including, but not limited to, spraying, brushing, and rolling. The preferred, and most technologically useful, method of applying the composition is by spraying. In one preferred embodiment, spraying is accomplished by using an airless sprayer that can optionally be a high-pressure airless sprayer. These aqueous compositions may advantageously be sprayed at a pressure of from about 1500 to about 3500 psi, more preferably from about 2000 to about 3200 psi, and more preferably from about 2300 to about 2800 psi. Also, these aqueous compositions may advantageously be sprayed at a temperature of from about 10° C. to about 82° C., more preferably from about 29° C to about 77° C., and more preferably from about 49° C to about 71° C.

When applying the coating to the exterior surface of a basement wall, a useful coating can be developed in a single spraying pass or by employing two to three spraying passes per application. Also, where thicker films or coatings are desired, multiple applications can be employed. In other words, one, or more spraying passes can be used to apply a first application, first application is preferably allowed to dry, and then one or more spraying passes may be employed to apply a second application. Once the coating has dried (i.e., the water has evaporated) the dried thickness of the coating is generally from about 15 to about 50 dry mils, preferably from about 20 to about 45 dry mils, more preferably from about 25 to about 40 dry mils, and still more preferably from about 30 to about 38 dry mils.

The compositions of this invention, when cured (by drying), form protective films or coatings that exhibit very unique and useful elastomeric properties with technologically useful recovery, adhesion to the substrate, and strength. In one or more embodiments, the strength and durability of the dried films or coatings is sufficient so as to obviate the need for an additional protective material (e.g., a polystyrene foam board), which is often used to protect films or coatings applied to below-grade walls prior to backfilling. In other embodiments, especially in those embodiments where a tackifying resin is employed, the cured films or coatings exhibit a technologically useful degree of residual tack, which allows for the direct application and adherence of insulation boards, protection boards, or drainage boards without the need for an added adhesive or mechanical fastener.

Accordingly, the compositions of this invention can advantageously be employed for forming a waterproof coating to the exterior surface of a wall, particularly a below-grade or basement wall. Advantageously, the coatings that result from the compositions of this invention are comparable in performance and characteristic to those coatings described in U.S. Pat. Nos. 5,932,646 and 5,925,706, and therefore the coatings of this invention have similar use and can be delivered in similar fashions. Accordingly, the disclosures of U.S. Pat. Nos. 5,932,646 and 5,925,706, are incorporated herein by reference. Further, the advantageous properties that are observed in the coatings of one or more embodiments are achieved without the use of a curative or without the need for crosslinking the rubber. Also, the advantages that are observed in one or more embodiments of this invention can be achieved without the use of an organic solvent. The coating or film is essentially the dried residue of a wet layer of the aqueous composition. Without wishing to be bound by any particular theory, the dried residue is believed to be a continuous matrix of the polymers within the latex; i.e., the polymers are believed to form a continuous phase as opposed to the discrete particles believed to exist within the latex composition.

In one or more embodiments, the tensile strength of a dried film having a thickness of about 26 mils is advantageously greater than about 180 psi, more advantageously greater than about 220 psi, even more advantageously greater than about 250 psi, and still more advantageously greater than about 270 psi when subjected to testing per ASTM D-412. Also, in one or more embodiments, the ultimate elongation of a dried film having a thickness of about 26 mils is advantageously greater than about 800%, more advantageously greater than about 900%, even more advantageously greater than about 1000%, and still more advantageously greater than about 1100% when subjected to testing per ASTM D-412. Further, in one or more embodiments, when subject to recovery tests, dried films advantageously demonstrate recovery of at least about 85%, more advantageously at least about 90%, even more advantageously at least about 95% and still more advantageously at least about 99%. Still further, in one embodiment, the dried films advantageously passed the crack-bridging criteria of ASTM C-836 at −26° C. The films of these embodiments advantageously demonstrate the ability to bridge gaps in excess of 1 mm, more advantageously in excess of 1.5 mm, even more advantageously in excess of 2.0 mm, and still more advantageously in excess of 2.5 mm.

In order to demonstrate the practice of the present invention, the following examples have been prepared and tested. The examples should not, however, be viewed as limiting the scope of the invention. The claims will serve to define the invention.

### EXAMPLES

A water-based coating composition was prepared by employing the following ingredients, which are set forth in Table I.

TABLE I

| Ingredient | % Weight | Real Weight |
|---|---|---|
| Texigel ™ 17-0330 (lbs) | 29.3 | 89 |
| Hartex ™ 101 (lbs) | 29.3 | 89 |
| Permatac ™ H7710 (lbs) | 14.8 | 45 |
| HD Phthalo Green ™ (lbs) | 3.0 | 9 |
| HD TiO₂ (lbs) | 1.3 | 4.5 |
| Texipol ™ 63-001 (lbs) | 2.3 | 7 |
| Water (lbs) | 19.8 | 60 |
| Defoamer DSX 3075 (lbs) | 0.1 | .31 |
| Total | 99.9 | 303.31 |

The composition was prepared as follows: in a lined, open-head drum, Texigel™ 17-0330 (Scott Bader), which is a styrene acrylic latex, and Hartex™ 101 (Firestone), which is a natural rubber latex was loaded. The Texigel™ 17-0330 was characterized by having a Brookfield viscosity at 25° C. of about 1,500 to about 2,000 cps, an average particle size of about 200 nm, and a glass transition temperature of about 20° C. The blend was mixed for five minutes. Subsequently, Permatac™ H7710 tackifying resin latex was loaded and stirred for five minutes. HD Phthalo Green™ and HD TiO₂ (both water based) was then added and stirring continued for five minutes.

3.4 lbs. of Texipol™ 63-001 thixotrope was loaded into five-gallon pail. 30 lbs. distilled water was added and stirred until completely thickened. The procedure was repeated with a second pail. The Texipol™ 63-001/water combination was slowly added into drum with constant stirring. The mixture was stirred for 15 minutes until it was smooth and thickened. Five ounces of defoamer was loaded and stirred for an additional five minutes.

A second water-based coating composition was prepared by employing the following ingredients, which are set forth in Table II.

TABLE II

| Ingredient | % Weight | Real Weight |
|---|---|---|
| Texigel ™ 13-090 | 34 | 2174 |
| Hartex ™ 101 | 34 | 2174 |
| HD Phthalo Green ™ | 2 | 13 |
| Blue Pigment | 1 | 7 |
| HD TiO₂ | 12 | 78 |
| Texipol ™ 63-001 | 25 | 163 |
| Water | 27 | 1758 |
| Foammaster I300 | 5 | 34 |
| Total | | 6401 |

This composition was prepared in a similar fashion to the composition prepared in the foregoing example except that the water, the Texigel™ 13-090 (Scott Bader), the Texipal 63-001, The Texigel™ 13-090, the pigments, and the Foammaster 1300 were first mixed together for about 10 minutes (or until a smooth and thickened composition was observed. Following this mixing, the Hartex™ 101 was subsequently added. The Texigel™ 13-090 was characterized by having a Brookfield viscosity at about 25° C. of about 1,500 to about 4,000 cps, an average particle size of about 200 nm, and a glass transition temperature (the first at 25° C., and the second at 7° C.). The Texigel™ 13-090 is believed to be a blend of two distinct styrene acrylic copolymers.

Dried films of about 20 to about 40 mils that were prepared from this composition advantageously exhibited sufficient strength and durability so that the films or coatings could be used as waterproofing coatings for below-grade walls without the need for an additional protective material or barrier.

Various modifications and alterations that do not depart from the scope and spirit of this invention will become apparent to those skilled in the art. This invention is not to be duly limited to the illustrative embodiments set forth herein.

1. A wall comprising:
a first surface; and
a protective coating covering at least a portion of the first surface, where the coating is the dried film of an aqueous composition comprising a first set of polymer particles characterized by having a glass transition temperature that is less than about −40° C., and a second set of polymer particles characterized by having a glass transition temperature in excess of about −25° C.

2. The wall of claim 1, where the first set of particles are characterized by having a glass transition temperature that is from about −70° C. to about −90° C.

3. The wall of claim 1, where the first set of particles are characterized by having an average particle size that is greater than 50 nm.

4. The wall of claim 1, where the first set of particles are characterized by having a Brookfield viscosity of from about 3 to about 500 cps.

5. The wall of claim 1, where the first set of particles include natural rubber particles.

6. The wall of claim 1, where the second set of particles are characterized by having a glass transition temperature that is from about 10° C. to about 40° C.

7. The wall of claim 1, where the second set of particles are characterized by having an average particle size that is greater than 50 nm.

8. The wall of claim 1, where the second set of particles are characterized by having a Brookfield viscosity of from about 5 to about 5,000 cps.

9. The wall of claim 1, where the second set of particles include polymers and copolymers derived from the polymerization of monomer including acrylic monomer.

10. The wall of claim 9, where the monomer further includes styrene.

11. The wall of claim 1, where the aqueous composition further comprises a thixotropic agent.

12. The wall of claim 1, where the aqueous composition further comprises a tackifying resin.

13. The wall of claim 1, where the aqueous composition has a solids content in excess of about 35% by weight.

14. The wall of claim 13, where the solids content of the aqueous composition includes greater than about 75% by weight of the first and second set of polymer particles.

15. The wall of claim 14, where the weight ratio of the first to the second set of polymer particles is from about 1.7:1 to about 1:1.7.

16. The wall of claim 11, where the thixotropic agent is present in an amount from about 1 to about 15 parts by weight per 100 parts by weight of the polymer particles.

17. The wall of claim 1, where the wall is a below-grade wall.

18. An aqueous composition for waterproofing walls, the composition comprising:
a first set of polymer particles characterized by having a glass transition temperature that is less than about −40° C., and a second set of polymer particles characterized by having a glass transition temperature in excess of about −25° C.

19. A method for waterproofing a below-grade wall, the method comprising:
applying an aqueous composition to the wall, the aqueous composition comprising a first set of polymer particles characterized by having a glass transition temperature that is less than about −40° C., and a second set of polymer particles characterized by having a glass transition temperature in excess of about −25° C.
